(19) United States
(12) Patent Application Publication
(10) Pub. No.: US 2007/0150338 A1
(43) Pub. Date: Jun. 28, 2007

(54) Systems, methods and computer programs for enabling interactive viewer control of advertising content

(76) Inventor: Dale Malik, Atlanta, GA (US)

Correspondence Address: JOHN S. PRATT;KILPATRICK STOCKTON LLP 36968, 1100 PEACHTREE STREET, SUITE 2800, ATLANTA, GA, 30309, US

(21) Appl. No.: 11/315,621

(22) Filed: Dec. 22, 2005

(51) Int. Cl. G06Q 30/00

(52) U.S. Cl. 705/14

(57) ABSTRACT

Systems, methods and computer programs enable interactive viewer control of advertising content. A monitor is configured to receive audio and video content having associated therewith an indicator that alternative content is available. The system comprises a first controller, a profile store and an advertisement store. The controller receives and stores viewer profile data in the profile store. The controller also receives advertisement content from the advertisement store. The controller provides an invitation to share viewer profile data with an advertiser. In turn, the controller forwards audio and video content in response to a communication responsive to the invitation.

### BACKGROUND

Advances in televised entertainment have made it possible for consumers to view programs from multiple sources. These multiple sources or program providers traditionally develop a series of separate programs, which they arrange in a predetermined schedule. Program providers are in constant competition to attract viewers. Programs that attract more viewers generally attract more advertising revenue. Accordingly, each program provider determines a schedule or program lineup to gain market share and revenue from advertising.

Advertisers generally purchase time from program providers in regular intervals. Advertisements are inserted before, during and after the broadcast or distribution of a program. Both advertisers and program providers rely on surveys conducted among test groups and projections using statistical analysis methods to determine information about the viewers and how many viewers observed advertisements associated with a particular program. Thus, surveys and statistical analysis techniques drive the market for advertisement time.

This arrangement between program providers and advertisers leads to a number of problems for both the advertisers and the viewing consumer. First, the advertiser pays for air time without the ability to direct select advertisements to particular viewing consumers. Second, viewers are presented numerous advertisements for undesired goods and services.

To overcome these limitations, some conventional systems, such as the system and method disclosed in U.S. Pat. No. 6,738,978 (the '978 patent), which is incorporated herein by reference, monitor a subscriber's viewing habits over time and apply a targeting routine that makes use of the subscribing viewer's demographic information and viewing habits to determine those advertisements that advertisers believe will be of most interest to that particular viewer. In so doing, the routine generates packages of advertisements targeted towards each viewer.

The conventional approach disclosed in the '978 patent has shortcomings. The described method relies on viewer demographics and viewing habits to select advertisements from various categories. While this approach may improve the likelihood that a particular advertisement will be presented to a viewer that might be interested in the subject matter of the advertisement, the approach is still one sided. That is, a viewer is presented a set of advertisements that the programmer of the advertising system wants to present to the viewer absent confirmation from the viewer. Using this approach, a set top terminal in a home with a twenty-five year old male subscriber that is frequently tuned to college football games on Saturdays in November is likely to receive commercial programming directed to trucks, sports cars and one or more domestic beers. It may be the case that the subscriber of record works weekends and that the viewing football fan is a twenty-two year old female roommate. In this case, commercial programming directed to trucks, sports cars and beer could be off the mark from the interests of the viewer and ignored.

Accordingly, despite the development of an approach to target advertising to a viewer there is still a need for improved approaches for presenting advertisements.

### SUMMARY

Embodiments of a system for use with a monitor configured to receive audio and video content comprise a controller, a profile store, and an advertisement store. The controller receives and stores viewer profile data in the profile store. The controller also receives advertisement content from the advertisement store. The controller provides an invitation to share viewer profile data with an advertiser. In turn, the controller forwards audio and video content in response to a communication responsive to the invitation.

An embodiment of a method for exposing viewer profile information to an advertiser comprises collecting a viewer profile, negotiating a schedule of advertisement content to be presented in association with a select program, establishing an interactive session with a viewer that desires to view the select program, receiving an indication during the interactive session that the viewer is willing to share information in their viewer profile with an advertiser and modifying the schedule of advertisement content in response to the indication.

An embodiment of a computer program product comprises executable instructions that when executed by a processor direct a system to establish a communication session with a viewer in response to an indication that a select program will be forwarded to the viewer, determine whether the viewer is agreeable to sharing information from a viewer profile with an advertiser, forward a value indicative of the advertisement content that will be presented in association with the select program and provide a menu of viewer selectable advertisement content that enables the viewer to observe advertisement content in accordance with the value.

Other systems, methods, features and advantages will be or will become apparent to one with skill in the art upon examination of the following figures and detailed description. All such additional systems, methods, features and advantages are defined and protected by the accompanying claims.

### BRIEF DESCRIPTION OF THE FIGURES

The systems, methods and computer programs can be better understood with reference to the following figures. The components within the figures are not necessarily to scale, emphasis instead being placed upon clearly illustrating the principles for enabling an interactive viewer session with advertising content. Moreover, in the figures, like reference numbers designate corresponding parts throughout the different views.

FIG. 1 is a block diagram illustrating an embodiment of a system configured to provide viewer selectable advertising content.

FIG. 2 is a schematic diagram illustrating embodiments of advertisement content in alternative schedules generated by the system of FIG. 1.

FIG. 3 is a schematic diagram illustrating an embodiment of a menu generated by the system of FIG. 1.

FIG. 4 is a block diagram illustrating an embodiment of the content provider of FIG. 1.

FIG. 5 is a flow diagram illustrating an embodiment of a method for exposing viewer profile information to an advertiser.

FIG. 6 is a flow diagram illustrating an embodiment of a computer program operative on the content provider of FIG. 1.

### DETAILED DESCRIPTION

Embodiments of the present system, method and computer program enable a viewer to interact with a multimedia content provider to control advertising content presented to the viewer. A content provider is coupled to one or more advertisers. The content provider, in response to a viewer communication, provides a default schedule of advertisement content associated with a select program. A viewer can selectively share information in a viewer profile with the content provider and/or an advertiser in exchange for an alternative schedule that includes a reduced amount of advertising content. Alternatively, a viewer can elect to provide information after viewing advertisement content. Under these circumstances, the viewer may be presented with an additional reduction in the overall duration of advertisement content associated with select program content. The content provider and an advertiser control the distribution of advertisement content available to the viewer. Under other circumstances, which may include the payment of a fee, a viewer could elect to bypass advertisement content.

The integration of available entertainment, communication and data networks is leveraged to provide select multimedia content to a specified viewing device. U.S. Pat. No. 5,818,438 (the '438 patent), the contents of which are incorporated by reference herein, discloses a system and method that provides an identifying code or interactive callback address along with information for directly invoking alternative multimedia content. A user of the system and method disclosed in the '438 patent can establish a session with a provider using the interactive callback address and other information and upon completion of the session, re-tune or select the original content for viewing.

The provider associates this identifying code or interactive callback address with a location at which the presently viewed programming or application will be stored. The identifying code or interactive callback address may be a program-specific code that can be used by viewers or subscribers to invoke one or more programs to configure a schedule of program and advertisement content. Alternatively, the identifying code may be a common identifying code or interactive callback address, used by all subscribing viewers to access a configuration menu, or an application-specific identifying code or interactive callback address, which is in turn used to invoke operational code within a content provider controller.

Viewers or subscribers are provided with a set top box or similar device adapted to be coupled to a multimedia-distribution network to which one or more service provider systems are also coupled and a suitable display device, such as a television monitor, a computer, etc. The set top box includes a receiving set capable of receiving broadband signals over the multimedia-distribution network. The set top box is configured to detect the presence and content of an identifying code or interactive callback address received by the receiving set either in a program signal (an in-band signal) or in an out-of-band signal. The set top box is also configured to store the identity of the source or channel on which the presently viewed programming is being received in one or more storage devices. The set top box is also configured to detect and store information accompanying the transmission of the identifying code or interactive callback address regarding an image to be displayed on the display device (such as a “key” or “icon”) or an audio message to be reproduced to indicate the availability of content, such as an interactive application, from the content server. Alternatively, such information regarding the image to be displayed or the message to be reproduced may be pre-stored in an appropriate storage device to which the set top box is coupled. The set top box is also coupled to a processor configured to generate a video image based on the received or pre-stored “key” or “icon” information, or alternatively, is programmed to generate the video signal and is coupled to the display device in such a manner as to provide such a signal to that device.

Furthermore, the set top box is adapted to establish a communication session over the multimedia distribution network with the content provider, upon receiving a request from the subscribing viewer in response to seeing the “icon” or hearing the message. The processor may first store in the information storage device the identity of the channel on which the program then being viewed is being transmitted. A communication session over a network to the content provider is then established by transmitting a message including the identifying code or interactive callback address. If the identification code or interactive callback address is a common identification code (for example, a “well-known callback address”) the content server returns the program- or application-specific identification code or interactive callback address, which the set top box then may use to invoke from the content provider an appropriate setup or configuration program.

The content provider transmits to the set top box the identity of a network service (i.e., a network address) or a channel on which the requested program and later advertisement information and/or content will be provided, and the set top box initiates a session with the indicated network service and/or causes the receiving set to tune to the channel. The set top box then receives the program and advertisement content in accordance with a negotiated schedule. During one or more communication sessions with a viewer, communication between the set top box and the content provider may be two-way.

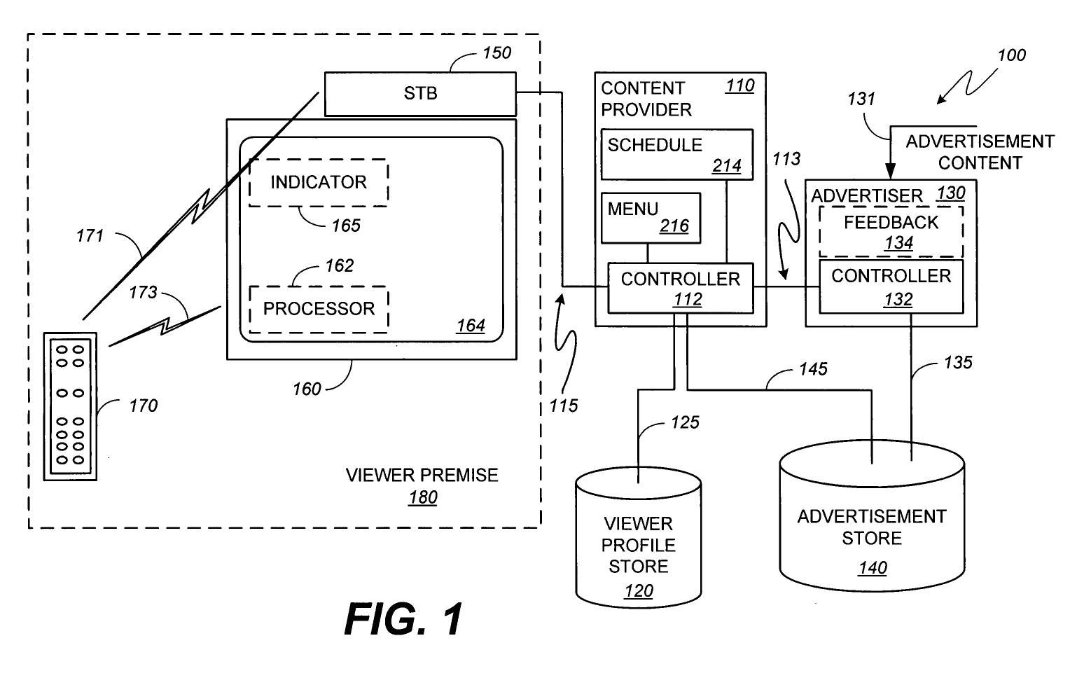

Having generally described the present system, method and computer program for exposing viewer profile information to an advertiser, various additional embodiments will be described with respect to FIGS. 1-6. By way of example, FIG. 1 is a block diagram illustrating an embodiment of a system 100 configured to expose viewer profile data to a content provider 110 and an advertiser 130. System 100 includes a viewer premise 180 that is communicatively coupled to content provider 110 via communication link 115. Content provider 110 is further coupled to advertiser 130, viewer profile store 120 and advertisement store 140.

Viewer premise 180 includes set top box 150, monitor 160 and one or more wireless controllers, such as multiple-function wireless controller 170. Wireless controller 170 communicates with set top box 150 via communication link 171 and monitor 160 via communication link 173. Wireless controller 170 provides a mechanism for a viewer to forward commands and information to content provider 110 via set top box 150. Set top box 150 communicates with content provider 110 and/or advertiser 130 via communication link 115. A subscriber of one or more multimedia services distributed by content provider 110 and delivered via set top box 150 to monitor 160 directs the operation of these services via set top box 150 and/or monitor 160 using wireless controller 170. As described generally above and in further detail below, wireless controller 170 and/or other controls associated with set top box 150 or monitor 160 are used to direct content provider 110 to forward program and advertisement information. Although depicted in FIG. 1 as a separate device, set top box 150 may be integrated with monitor 160 and or other devices coupled to monitor 160 located in viewer premise 180.

Content provider 110 includes a controller 112 and storage buffers to hold one or more schedules, such as schedule 214 and one or more menus, such as menu 216. Content provider 110 is coupled to advertiser 130 via link 113 as well as viewer profile store 120 and advertisement store 140 via links 125 and 145, respectively. Controller 112 is configured to manage the receipt and storage of viewer profiles in viewer profile store 120, as well as manage communication sessions with set top box 150 and advertiser 130. In addition, controller 112 receives advertisement content from advertisement store 140 in accordance with schedule 214. Moreover, content provider 110 includes various devices that enable content provider 110 to distribute one or more channels of multimedia content via link 115 in accordance with commands received from set top box 150.

Advertiser 130 includes a controller 132 and one or more storage buffers to hold information from viewers such as feedback buffer 134. Advertiser 130 is coupled to producers or other sources of advertisements via link 131 and advertisement store 140 via link 135 in addition to content provider 110 via link 113. Advertiser 130 includes controller 132 which is configured to receive advertisements via link 131 and store the same in advertisement store 140. Moreover, controller 132 is configured to manage communication sessions with content provider 110.

As described above and in the '438 patent, one or more indicators, such as indicator 165 is integrated within the various multimedia signals communicated from content provider 110 to indicate that alternative content is available from content provider 110. Alternative content includes one or more of schedule 214, menu 216 and advertisements arranged in accordance with schedule 214 from advertisement store 140.

Although the embodiment illustrated in FIG. 1 depicts link 113, link 115, link 125, link 135 and link 145 as wired media, it should be understood that portions of one or more of these links may be wireless terrestrial based and/or satellite links. In addition, portions of advertiser 130 including one or both of controller 132 and feedback buffer 134 may be integrated with content provider 110 or be distributed across multiple sources (not shown). Moreover, advertisement store 140 and viewer profile store 120 may be integrated across one or more co-located storage devices under the direction of content provider 110.

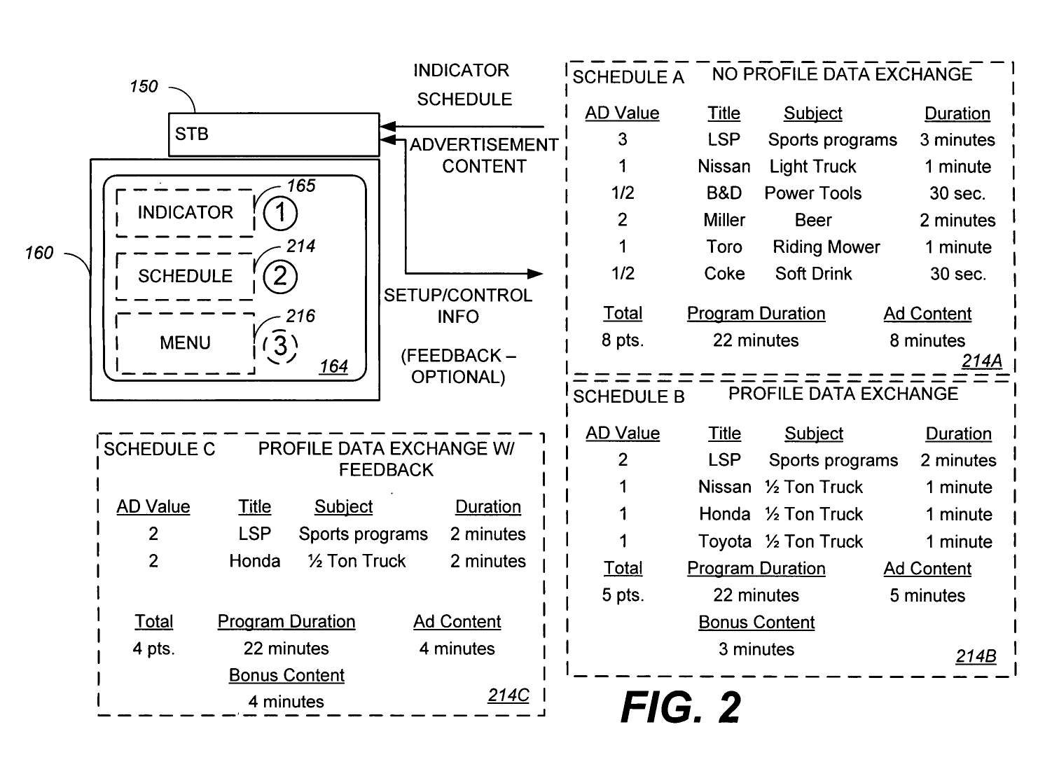

FIG. 2 is a schematic diagram illustrating embodiments of advertisement content in alternative schedules 214 generated by the system 100 of FIG. 1. The schematic diagram includes a sequence of encircled numbers from 1 through 3 that are indicative of an example sequence of actions, events and information transfers that occur during the setup of an advertisement content schedule within an interactive session between a viewer and content provider 110. As described above and noted by the encircled number “1,” content provider 110 and/or set top box 150 are configured to work in conjunction with monitor 160 to present indicator 165 on display 164 or provide an audio message via monitor 160 or other coupled devices at a viewing premise.

In response to the indicator 165 and indicated by an encircled “2”, a subscriber or viewer of content provided by content provider 110 uses a wireless controller 170 configured to communicate with monitor 160 and set top box 150 to receive a default advertisement schedule. An example default advertisement schedule is reflected in schedule 214A labeled, “Schedule A.” A schedule identifies a relationship between program content and advertisement content that will be broadcast or otherwise provided by content provider 110 to the viewer. Absent the viewer's authorization to share information within the viewer profile, content provider 110 presents a first quantity or level of advertisement content in association with the telecast. Default advertisement schedule 214A defines the advertisement content that will be presented over a select portion of a telecast of a live baseball game when the viewer elects not to share viewer profile information with content provider 110 and/or advertiser 130. As is shown, the subject matter of the individual advertisements in schedule 214A reflects representative products that may appeal to viewers of a baseball game.

A viewer can elect to accept default schedule 214A or can use controller 170 or set top box 150 to initiate menu 216. Menu 216 provides a mechanism for the viewer to share information from a personal viewer profile and/or share additional information with content provider 110 and advertiser 130. As indicated by the encircled “3,” menu 216 represents an optional response to default schedule 214A. When a viewer uses menu 216 to share viewer profile data with content provider 110 and advertiser 130, a second level of advertisement content will be associated with the program content. This second level of advertisement content is exemplified in a first alternative advertisement content schedule 214B labeled, “Schedule B.” As shown in FIG. 2, advertisement content in alternative schedule 214B represents a reduced amount of advertisement content run time when compared to the advertisement run time of default schedule 214A. As further indicated in alternative schedule 214B, the reduced advertisement content run time can be filled with bonus content, or continuous viewing. Bonus content may include information regarding various additional services and products offered by content provider 110 or information concerning advanced menu features. When a viewer communicates that they wish to provide feedback to content provider 110 and advertiser 130 via menu 216 or some other communication medium, a third level of advertisement content will be associated with the program content. This third level of advertisement content is exemplified in a second alternative advertisement content schedule 214C labeled, “Schedule C.” Advertisement content in alternative schedule 214C represents a reduced amount of advertisement content run time when compared to the advertisement run time of both default schedule 214A and first alternative advertisement content schedule 214.

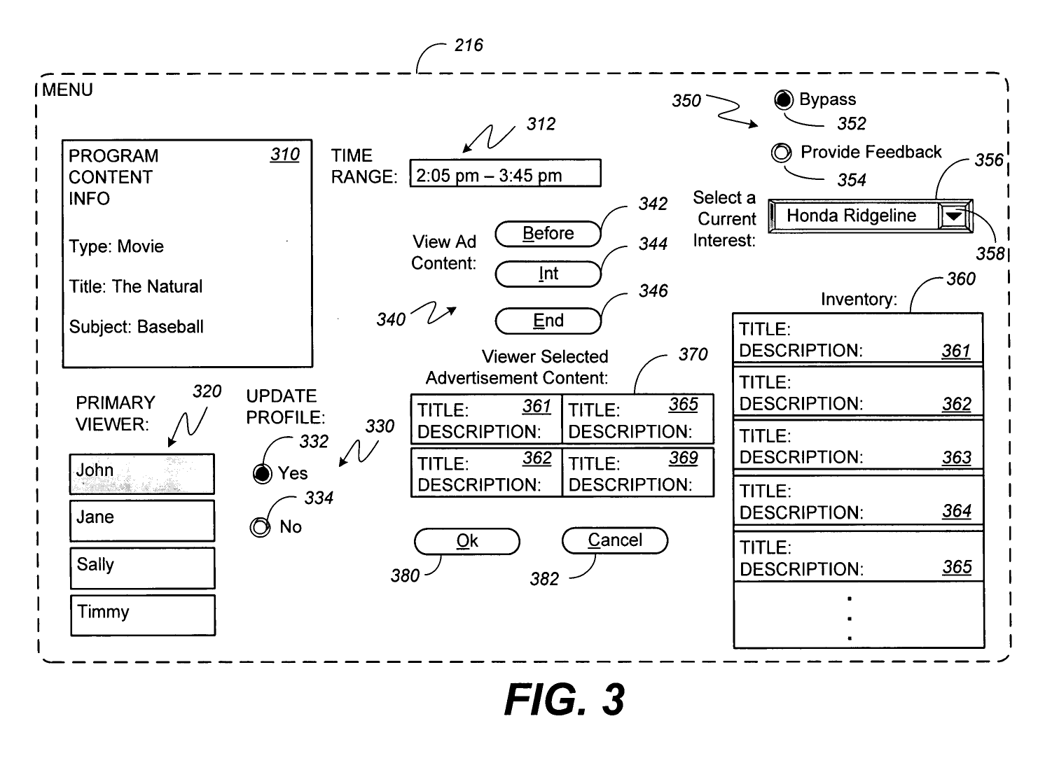

FIG. 3 is a schematic diagram illustrating an embodiment of menu 216 generated by the system 100 of FIG. 1. Menu 216 includes a host of items that enable a viewer to communicate with content provider 110. In one embodiment, menu 216 is presented via monitor 160. When presented via monitor 160, items may be displayed in conjunction with program content. Alternatively, menu 216 may be displayed on monitor 160 separately from program content. In alternative embodiments, menu 216 is communicated to a viewer using a browser or other software operative on a computing device coupled to a data network. In the illustrated embodiment, program information frames, advertisement content frames, and viewer controls appear simultaneously. In operation, one or more frames and viewer controls may be inactivated and obscured from observation by a viewer. In this way a viewer may interact with menu 216 while watching underlying content on monitor 160.

Menu 216 includes program content information frame 310 and time range frame 312 that communicate to a viewer the identity of the program content and the time when the program content will be broadcast to monitor 160. The remainder of menu 216 includes viewer controls and advertisement content information. Primary viewer interface 320 presents a list of possible viewers and includes a mechanism for selecting a primary viewer that will watch the program content. In the illustrated embodiment, the mechanism is a highlight bar that can be selectively positioned or scrolled by the operator of control device 170. Profile interface 330 includes indicator 332 that indicates that the presently highlighted primary viewer desires to review information in their viewer profile and indicator 334 that indicates that the primary viewer does not want to review or change their viewer profile information. Timing interface 340 includes pushbutton 342, pushbutton 344 and pushbutton 346. When activated, pushbutton 342 indicates that the viewer would like to be presented advertisement content associated with the program content before the program content is presented. Pushbutton 344 indicates that the viewer would like to be presented advertisement content during an intermission or other intervals throughout the broadcast of the select program content. Pushbutton 346 indicates that the viewer would like to be presented advertisement content after the completion of the select program content. Interface 350 includes pushbutton 352, pushbutton 354 and data entry field 356. When activated, pushbutton 355 indicates that the primary viewer is willing to share their viewer profile to receive less advertisement content that is directed to the viewer in accordance with information in the viewer profile. Pushbutton 354 is configured to indicate that the primary viewer is willing to provide information after observing the advertisement content presented in association with the current program content. Data entry field 356 is configured to receive information from the primary viewer that identifies a current interest or desire. Data entry field 356 is associated with indicator 358, which when activated by the viewer enables a drop-down list of previously entered interests. The viewer can revisit a previously entered topic by selectively highlighting a desired interest.

Menu 216 also includes inventory frame 360 and sequence frame 370. Inventory frame 360 includes one or more viewer selectable advertisements. In the illustrated embodiment, inventory frame includes advertisement 361, advertisement 362, advertisement 363, advertisement 364, advertisement 365, etc. One or more of the advertisements that appear in inventory frame 360 are in response to information provided or otherwise observable on menu 216. Sequence frame 370 includes a list of select advertisements from inventory frame 360. Individual advertisements within sequence frame 370 will be presented to the viewer(s) in accordance with the primary viewer's selection from timing interface 340.

Menu 216 further includes pushbutton 380 and pushbutton 382. When selected, pushbutton 382 cancels data entered via the last interface that the viewer manipulated during the present communication session with content provider 110. Subsequent entry of pushbutton 382 cancels data entered via the next to last interface manipulated by the viewer. When it is the case that an interface was not changed or that all modified interfaces have been returned to a previous state, activation of pushbutton 382 will close menu 216 and return the viewer to the content or channel that was being viewed when menu 216 was initiated. When activated, pushbutton 380 forwards viewer selectable information from menu 216 to content provider 110. In turn, content provider 110 may apply one or more rules against the received information to determine if the viewer has arranged a schedule of advertisement content that meets criteria set by one or both of the content provider 110 and advertiser 130. When it is the case that the viewer has not arranged an acceptable schedule, content provider 110 may provide additional information via menu 216 (not shown) or an audio message to direct the viewer. Otherwise, when the schedule is acceptable, content provider 110 directs the termination of menu 216 and provides the select program content or advertisement content in accordance with the schedule.

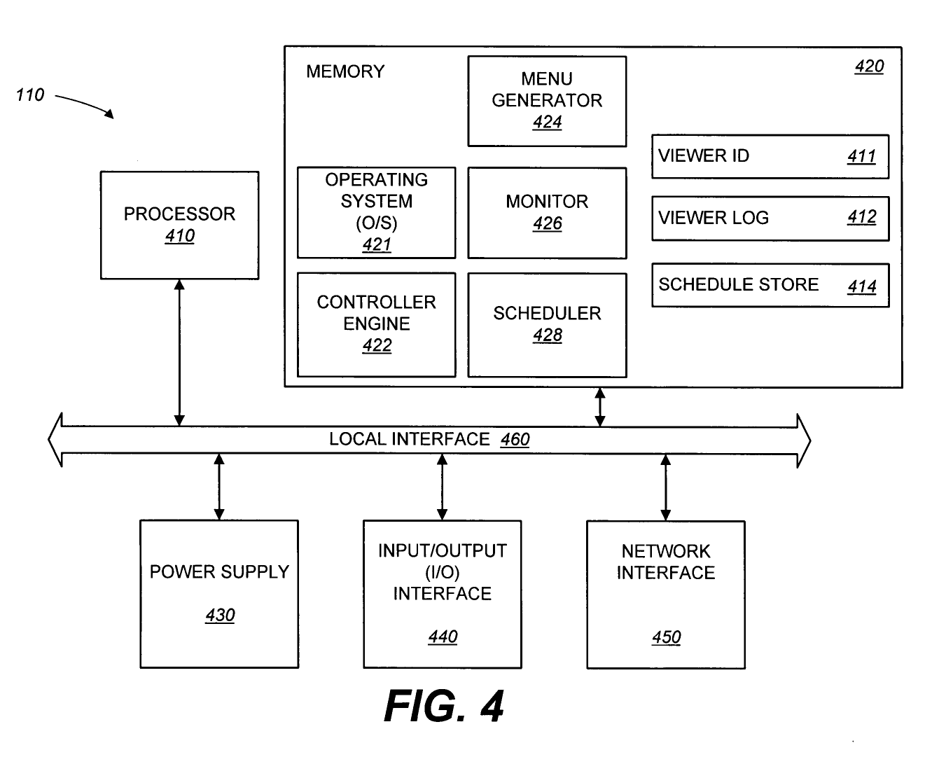

FIG. 4 is a block diagram illustrating an embodiment of the content provider 110 of FIG. 1. Generally, in terms of hardware architecture, content provider 110 includes processor 410, memory 420, power supply 430, input/output (I/O) interface 440 and network interface 450. Processor 410, memory 420, power supply 430, I/O interface 440 and network interface 450 are communicatively coupled via local interface 460. Local interface 460 can be, for example but not limited to, one or more buses or other wired or wireless connections, as is known in the art. Local interface 460 may have additional elements, which are omitted for simplicity, such as controllers, buffers (caches), drivers, repeaters, and receivers, to enable communications. Further, local interface 460 may include address, control, and/or data connections to enable appropriate communications among the aforementioned components.

Power supply 430 provides power to each of the processor 410, memory 420, I/O interface 440, network interface 450 and local interface 460 in a manner understood by one of ordinary skill in the art.

Processor 410 is a hardware device for executing software, particularly that stored in memory 420. The processor 410 can be any custom made or commercially available processor, a central processing unit (CPU), an auxiliary processor among several processors associated with the content provider 110, a semiconductor based microprocessor (in the form of a microchip or chip set), or generally any device for executing software instructions.

The memory 420 can include any one or combination of volatile memory elements (e.g., random-access memory (RAM, such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disc read-only memory (CDROM), etc.). Moreover, the memory 420 may incorporate electronic, magnetic, optical, and/or other types of storage media. Note that the memory 420 can have a distributed architecture, where various components are situated remote from one another, but can be accessed by the processor 410.

The software in memory 420 may include one or more separate programs, each of which comprises an ordered listing of executable instructions for implementing logical functions in addition to identified locations for data storage. In the example of FIG. 4, the software in the memory 420 includes operating system 421, controller engine 422, menu generator 424, monitor 426 and scheduler 428. Identified locations for data storage include viewer identifier store 411, viewer log store 412, and schedule store 414. The operating system 421 essentially controls the execution of other programs, such as controller engine 422, menu generator 424, monitor 426 and scheduler 428 and provides scheduling, input-output control, file and data management, memory management, and communication control and related services.

Controller engine 422 includes logic configured to manage communication sessions with one or more subscribers or viewers via set top box 150 as well as one or more communication sessions with advertiser 130 via communication link 113. Controller engine 422 further includes logic configured to coordinate the operation of menu generator 424, monitor 426 and scheduler 428. As described above, content provider 110 and advertiser 130 negotiate or otherwise develop a default schedule of advertisement content in association with the distribution of program content.

Scheduler 428 includes logic for generating the default schedule as well as alternative schedules. Generally, the default schedule comprises a minimum level of advertisement content that will be presented to a viewer in association with the presentation of select program content to the viewer. As also described above, controller engine 422, under viewer direction, may controllably expose information from viewer profile store 120 (FIG. 1) and in turn communicates with scheduler 428 to generate an alternative schedule for the viewer that requires the viewer to observe less advertisement content. In one embodiment, these alternative schedules are prepared in accordance with pre-configured rules negotiated between content provider 110 and advertiser 130 in exchange for the opportunity to present select or target advertisement content to the viewer in accordance with information stored in viewer profile store or otherwise communicated by the viewer. As indicated in FIG. 4, memory 420 includes schedule store 414 for retaining one or more of the default or alternative schedules defining the advertisement content that will be presented to the viewer in association with a select program.

Menu generator 424 includes logic for creating items to be communicated to the viewer via set top box 150. The items include fields for presenting program content information, viewer selected advertisement content, an inventory of available ads, as well as a host of tools for navigating or otherwise manipulating viewer information, viewer profile information, and one or more mechanisms for indicating what the viewer is willing to share with advertisers through content provider 110, etc. Some example tools include viewer selectable pushbuttons, highlight bars, and a pull-down option tab although more or less tools can be applied across the menus. Although illustrated embodiments include graphical elements, it should be understood that monitor 160 may be sent one or more audio messages to communicate with the viewer.

Monitor 426 includes logic that records or otherwise observes viewer activity over time. In this regard, monitor 426 associates both available program content and available alternative content provided via set top box 150 with a viewer and selectively sends information identifying viewer commands along with information about content to viewer log 412. Monitor 426 further includes logic that communicates to controller engine 422 when the viewer has acted in accordance with an agreed schedule for advertisement content or the combination of advertisement content and viewer feedback.

Controller engine 422, menu generator 424, monitor 426 and scheduler 428 are source programs, executable programs (object code), scripts, or any other entities comprising a set of instructions to be performed. When implemented as source programs, the programs are translated via a compiler, assembler, interpreter, or the like, which may or may not be included within the memory 420, so as to operate properly in connection with the O/S 421. Furthermore, controller engine 422, menu generator 424, monitor 426 and scheduler 428 can be written in one or more object-oriented programming languages, which have classes of data and methods, or procedure programming languages, which have routines, subroutines, and/or functions.

I/O interface 440 is a hardware device for communicatively coupling local input devices, for example but not limited to, a keyboard, mouse, scanner, microphone, etc. Furthermore, I/O interface 440 communicatively couples local output devices, for example but not limited to, a printer, display, etc. These local I/O devices may be provided to configure and maintain content provider 110 as desired.

Network interface 450 is a hardware device for communicatively coupling set top box 150 and one or more wireless communication devices to content provider 110 via various wired and wireless networks. In this regard, network interface 450 may include devices that communicate both inputs and outputs, for instance but not limited to, a modulator/demodulator (modem; for accessing another device, system, or network), a radio frequency (RF) or other transceiver, a telephonic interface, a bridge, a router, etc.

Network interface 450 exposes content provider 110 to wired and wireless data networks, including but not limited to, community access television (CATV) distribution networks, satellite broadcast networks, public switched telephone network (PSTN) based communication services and other data networks. Accordingly, network interface 450 is configured to perform the signal conditioning and format conversions to communicate data between content provider 110 and a viewer premises. Under some circumstances, signal conditioning and format conversions include the performance of a variety of functions including, for example: answering a phone line; hanging-up a phone line; dialing a phone number; sending data signals; receiving data signals; generating dual tone multi-frequency (DTMF) tones; detecting DTMF tones; receiving automatic number identification—the number from which a caller initiates a call (ANI) and dialed number identification service—the number dialed by the caller (DNIS) playing voice messages; and converting voice signals between analog and digital formats. Under some other circumstances, signal conditioning and format conversions include encoding and encapsulating data in packets under one or more protocols including transmission control protocol/Internet protocol (TCP/IP), among others.

When content provider 110 is in operation, the processor 410 is configured to execute software stored within the memory 420, to communicate data to and from the memory 420, and to generally control operations of the content provider 110 pursuant to the software and data elements. Controller engine 422, menu generator 424, monitor 426, scheduler 428 and the O/S 421, in whole or in part, but typically the latter, are read by the processor 410, perhaps buffered within the processor 410, and then executed.

When controller engine 422, menu generator 424, monitor 426 and scheduler 428 are implemented in software, as is shown in FIG. 4, it should be noted that these software elements can be stored on any computer-readable medium for use by or in connection with any computer related system or method. In an alternative embodiment, where one or more of the controller engine 422, menu generator 424, monitor 426 and scheduler 428 are implemented in hardware, the controller engine 422, menu generator 424, monitor 426 and scheduler 428 can implemented with any or a combination of the following technologies, which are each well known in the art: a discrete logic circuit(s) having logic gates for implementing logic functions upon data signals, an application-specific integrated circuit (ASIC) having appropriate combinational logic gates, a programmable gate array(s) (PGA), a field-programmable gate array (FPGA), etc.

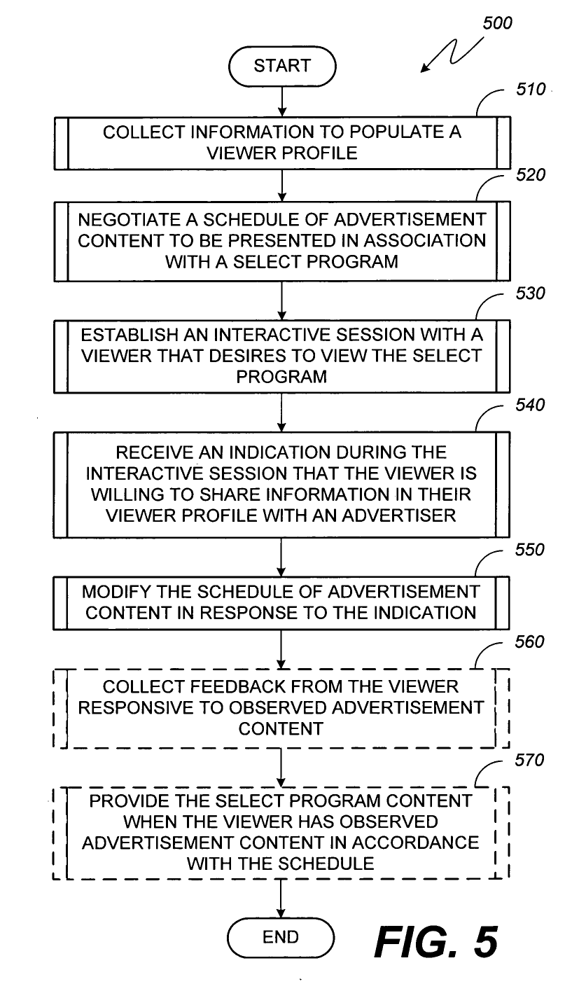

FIG. 5 is a flow diagram illustrating an embodiment of a method 500 for exposing viewer profile information to an advertiser. In this regard, each block represents a specified step or function. When embodied in software and/or a hardware device, each block represents a module, segment, or portion of code, which comprises one or more executable instructions for implementing the specified function(s). Method 500 begins with block 510 where content provider 110 collects information to populate a viewer profile. In block 520, the content provider 110 negotiates a schedule of advertisement content to be presented in association with a select program. In block 530, content provider 110 establishes an interactive session with a viewer that desires to view the select program. During the interactive session, the content provider 110 may receive an indication that the viewer is willing to share information in their viewer profile with an advertiser, as shown in block 540. The indication can be forwarded by the viewer in accordance with a previously configured viewer profile, or may be forwarded in accordance with a real-time viewer input.

Upon receipt of the indication that a viewer is willing to share information from their viewer profile, content provider 110 modifies the schedule of advertisement content as shown in block 550. In one embodiment, content provider 110 produces a schedule with a reduced duration. That is, in exchange for sharing viewer specific information, the viewer receives the benefit of having to observe less advertisement content than the advertisement content that will be forwarded to viewers that do not share their viewer profile in order to receive the program content. In an alternative and optional embodiment, content provider 110 collects feedback from the viewer in response to observed advertisement content, as indicated in block 560. In another alternative and optional embodiment, content provider 110 provides the select program content when the viewer has observed advertisement content in accordance with the schedule, as shown in optional block 570.

In some embodiments, the viewer may be presented with options during the interactive session or an additional interactive session concerning both what advertisement content is presented and when. For example, a viewer may elect to observe required advertisement content prior to observing program content in its entirety commercial free. In an alternative example, the viewer may elect to view a first portion of a select program without viewing corresponding advertisement content. Under these circumstances, the content provider 110 may simply record or otherwise log the duration of commercial free viewing and bill the viewer later, or may prompt the viewer at one or more times during the select program to view advertisement content in order to view subsequent portions of the select program.

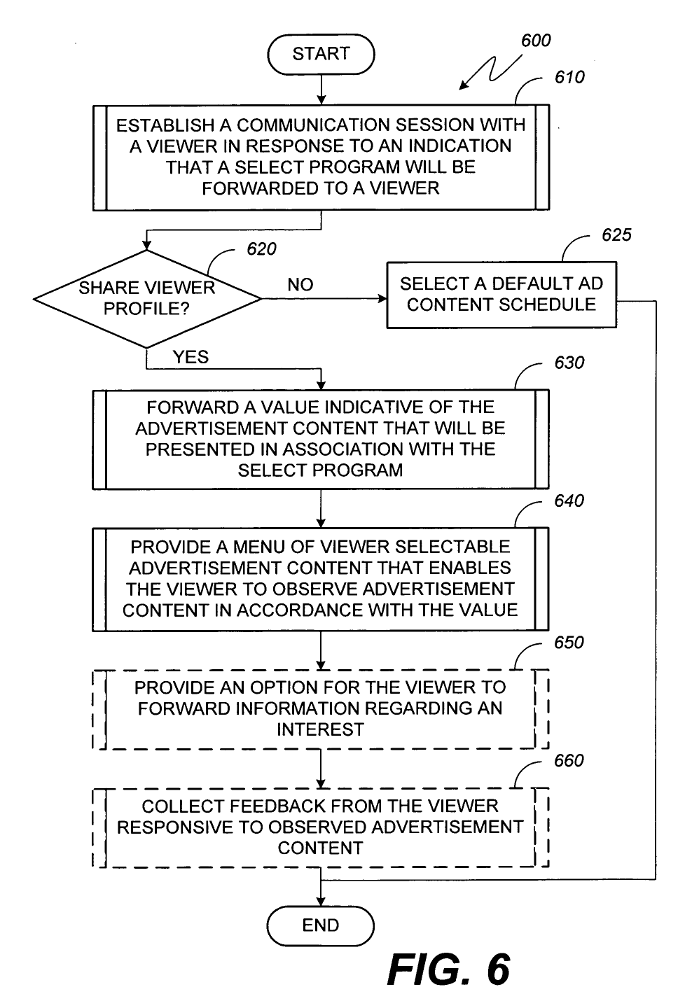

FIG. 6 is a flow diagram illustrating an embodiment of a computer program operative on the content provider of FIG. 1. In this regard, each block represents a specified step or function. When embodied in software and/or a hardware device, each block represents a module, segment, or portion of code, which comprises one or more executable instructions for implementing the specified function(s). Method 600 begins with block 610 where content provider 110 establishes a communication session with a viewer in response to an indication that a select program will be forwarded to a viewer. Next, as indicated in query 620, a determination is made to determine whether the viewer will share information from a viewer profile with an advertiser. When the response to query 620 is negative, as indicated by the flow control arrow labeled “No” exiting query 620, the content provider 110 selects a default schedule of advertisement content at block 625 to present to the viewer in association with the select program content. Otherwise, when the response to query 620 is affirmative, as indicated by the flow control arrow labeled, “Yes” exiting query 620, the content provider 110 continues by forwarding a value indicative of advertisement content that will be presented in association with the select program content as indicated in block 630. Thereafter, content provider 110 provides a menu of viewer selectable advertisement content that enables the viewer to observe advertisement content in accordance with the value at block 640.

One or more optional steps may be added to method 600. For example, as indicated in block 650 content provider 110 provides an option for the viewer to forward information of interest. Forwarded information can be used to update a respective viewer profile, filter or otherwise select advertisement content from that available in advertisement store 140, or both. By way of further example, as shown in block 660, content provider 110 collects feedback from the viewer responsive to observed advertisement content.

Operational software programs that may be used by content provider 110 and advertiser 130, as well as operational software that may be used in conjunction with controllers, browsers, monitors, computers, among other devices that interface with system 100, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a RAM, a ROM, an erasable programmable read-only memory (EPROM or Flash memory) (magnetic), an optical fiber (optical), and a portable CDROM (optical). Note that the computer-readable medium could even be paper or another suitable medium upon which the program is printed and the program can be electronically captured, via for instance, optical scanning of the paper or other medium, then compiled, interpreted or otherwise processed in a suitable manner if necessary, and then stored in a computer memory.

Any process descriptions or blocks in the flow diagrams of FIGS. 5 and 6 should be understood as representing modules, segments, or portions of code, which include one or more executable instructions for implementing specific logical functions or steps in the methods for exposing viewer profile information to an advertiser. Alternate implementations are within the scope of the presented system in which functions may be executed out of order from that shown or discussed, including substantially concurrently or in reverse order, and/or manually, depending on the functionality involved, as would be understood by those reasonably skilled in the art.

The systems, methods and computer-program products for exposing viewer profile information to an advertiser are defined by the appended claims. The foregoing description has been presented for purposes of illustration and description to enable one of ordinary skill to make and use the systems, methods and computer-program products to enable a viewer to control advertising content. The foregoing description is not intended to be exhaustive or to limit the scope of the claims to the precise forms disclosed. Rather, a person skilled in the art will construe the appended claims broadly, to include other variants and embodiments, which those skilled in the art may make or use without departing from the claimed systems, methods and computer-program products and their equivalents.

What is claimed is:

1. A system for use with a monitor configured to receive audio and video content, the audio and video content having associated therewith an indicator that alternative content is available, the system comprising:
a first controller configured to receive viewer profile data;
a profile store coupled to the first controller and configured to store viewer profile data; and
an advertisement store coupled to the first controller and configured to store advertisement content, wherein the first controller is configured to forward an invitation to share viewer profile data with an advertiser and alternative audio and video content in response to a communication responsive to the invitation.

2. The system of claim 1, wherein the indicator comprises one of an image presented to the viewer in the video content and a message in the audio content.

3. The system of claim 1, further comprising:
a second controller coupled to the first controller and the advertisement store, the second controller configured to receive advertisement content and negotiate a schedule of advertisement content to be associated with program content and presented to the viewer.

4. The system of claim 3, wherein the schedule comprises a first level of advertisement content.

5. The system of claim 4, wherein the schedule comprises a second level of advertisement content lower than the advertisement content at the first level, the second level of advertisement content responsive to an affirmative viewer communication.

6. The system of claim 5, wherein the viewer communication comprises an agreement to provide information responsive to advertisement content.

7. The system of claim 6, wherein the first controller initiates a communication session with a viewer.

8. The system of claim 3, wherein the first level of advertisement content is lower than the advertisement content associated with viewers without corresponding data in the viewer profile store.

9. The system of claim 3, wherein the schedule of advertising content comprises a value indicative of the advertisement content associated with a select program.

10. The system of claim 9, wherein the first controller communicates a menu for presentation via the monitor to the viewer.

11. The system of claim 10, wherein the viewer selects an option presented via the menu that directs the first controller to modify the advertisement content that will be presented to the viewer.

12. The system of claim 10, wherein the first controller forwards program content in response to a qualifying condition.

13. A method for exposing viewer profile information to an advertiser, comprising:
collecting a viewer profile;
negotiating a schedule of advertisement content to be presented in association with a select program;
establishing an interactive session with a viewer that desires to view the select program;
receiving an indication during the interactive session that the viewer is willing to share information in their viewer profile with an advertiser; and
modifying the schedule of advertisement content in response to the indication.

14. The method of claim 13, wherein establishing an interactive session comprises providing an interactive callback address in a data stream.

15. The method of claim 13, wherein establishing an interactive session comprises providing an interactive menu that enables a viewer to controllably adjust the schedule of advertisement content.

16. The method of claim 13, further comprising:
collecting feedback from the viewer responsive to observed advertisement content.

17. The method of claim 13, further comprising:
providing the select program content when the viewer has observed advertisement content in accordance with the schedule.

18. A computer program product for exposing viewers to advertisers, comprising computer-readable executable instructions that when executed by a processor direct a system to perform a method of:
establishing a communication session with a viewer in response to an indication that a select program will be forwarded to the viewer;
determining that the viewer is agreeable to sharing information from a viewer profile with an advertiser;
forwarding a value indicative of the advertisement content that will be presented in association with the select program;
providing a menu of viewer selectable advertisement content that enables the viewer to observe advertisement content in accordance with the value.

19. The computer program product of claim 18, further comprising:
collecting feedback from the viewer responsive to observed advertisement content.

20. The computer program product of claim 18, further comprising:
providing an option for the viewer to forward information regarding an interest.
